(19) United States
(12) Patent Application Publication
(10) Pub. No.: US 2008/0236677 A1
(43) Pub. Date: Oct. 2, 2008

(54) SCRUBBER SYSTEM IN SEMICONDUCTOR

(76) Inventors: Chieh-Hsing Chen, Kao-Hsiung City (TW); Tsung-Yang Chen, Tai-Nan City (TW)

Correspondence Address: NORTH AMERICA INTELLECTUAL PROPERTY CORPORATION, P.O. BOX 506, MERRIFIELD, VA, 22116, US

(21) Appl. No.: 11/693,733

(22) Filed: Mar. 30, 2007

(51) Int. Cl. F01N 3/00; F16K 17/00

(52) U.S. Cl. 137/455; 137/552; 137/861; 422/169

(57) ABSTRACT

A scrubber system in semiconductor includes a local scrubber, a plurality of pipelines connecting at least a process equipment to the local scrubber, and a flow balancing piping. The flow balancing piping includes a connecting duct, a plurality of flow balancing manifolds connecting the pipelines to the connecting duct, a plurality of first flow balancing valve respectively positioned on the flow balancing manifolds, and at least a second flow balancing valve positioned on the connecting duct.

### BACKGROUND OF THE INVENTION

1. Field of the Invention

The present invention relates to a scrubber system in semiconductor, and more particularly, to a scrubber system in semiconductor that effectively improves unbalanced gas flow volume.

2. Description of the Prior Art

High technology development, such as semiconductor manufacture, has been a global aspiration, and accordingly, influences and dangers, which are caused by air pollutants released by this industry, to ambient air quality cannot be ignored. For example, process exhaust gases, such as volatile organic compounds (VOCs), including nitric acid, hydrochloric acid, phosphoric acid, hydrofluoric acid, and sulfuric acid particularly need to be controlled because they may induce adverse health effects such as malignant tumors, mutation, teratogenicity, and endanger skin and the central nervous system.

It is familiar to those skilled in the art that the process exhaust gases from semiconductor foundries are categorized into: (1) acidic/basic gaseous pollutants, such as hydrofluoric acid, hydrochloric acid, nitric acid, sulfuric acid, and calcium hydroxide, etc., (2) organic solvents, such as methylene chloride, chloroform (CHCl₃), methyl ethyl ketone, toluene, etc., (3) toxic gases, such as arsenic hydrid (AsH₃), silane (SiH₄), diborane (BF₃), etc., and (4) combustible gases, such as silane, arsenic hydrid, boron fluoride, hydrogen, etc. Due to the dangers to humans and the environment, those gases have to be treated in a central scrubber system before being released into the atmosphere.

However, usually there is a distance between the working area and the central scrubber system, so some gases may crystallize or cause dust depositions in the transit duct on the way to the central scrubber system and cause obstruction or corrosion, or even cause an explosion or a blaze in the transit duct. To protect the transit duct and operators from such threats, a local scrubber system is equipped by the semiconductor foundry to treat the process exhaust gases before transmission to the central scrubber system and to reduce the process exhaust gases remaining in the working area.

Local scrubber systems are categorized into (1) thermal-wet type; (2) controlled decomposition/oxidation (CDO); (3) packing tower scrubbers; and (4) dry scrubbers. Each type of the local scrubber system has its own advantages for different requirements. Among the local scrubber systems, the CDO local scrubber system applies a double treatment to the gases: heating the gases at a high temperature to perform an intense decomposition/oxidation, and performing a two-stage or three-stage water mist wash. By combining decomposition/oxidation and washing, the CDO local scrubber is particularly suitable to treat gases comprising a great quantity of dust and thus is widely used in semiconductor foundries.

Please refer to FIG. 1, which is a schematic drawing of a conventional local scrubber system and piping. As shown in FIG. 1, at least a process equipment 10 is connected to a CDO local scrubber 60 by a plurality of pipelines 20, 30, 40, and 50. Gas volume in the local scrubber 60 is limited to 200 liters (L), therefore a gas flow volume in each pipeline 20, 30, 40, 50 is limited to 50 L. Practically, gas flow volumes in the pipelines 20, 30, 40, 50 are different, and when the gas flow volume in one of the pipeline exceeds the limit, a backup local scrubber 62 and one of backup pipelines 22, 32, 42, 52 are provided, and the pipeline containing gas flow volume exceeding the limit is bypassed to its corresponding backup pipeline. Another option is to adjust the points of admission for the gases. These deployments are used to prevent the gas volume in the pipelines 20, 30, 40, 50 and the local scrubber 60 from exceeding the limit and from danger. However, a cost for equipping the backup local scrubber 62 and the backup pipelines 22, 32, 42, 52 or adjusting the point of admission not only is high, but also requires further consideration for re-deploying of the pipelines.

### SUMMARY OF THE INVENTION

Therefore the present invention provides a scrubber system in semiconductor to improve unbalanced gas flow volume without deploying a backup scrubber or pipeline, or adjusting the point of admission.

According to the present invention, a scrubber system in semiconductor is provided. The scrubber system in semiconductor comprises a local scrubber, a plurality of pipelines connecting at least a process equipment to the local scrubber, and a flow balancing piping. The flow balancing piping comprises a connecting duct, a plurality of flow balancing manifolds connecting the pipelines to the connecting duct, a plurality of first flow balancing valves positioned on the flow balancing manifolds respectively, and at least a second flow balancing valve positioned on the connecting duct.

In the flow balancing piping provided by the present invention, the pipelines are connected to the connecting duct through the flow balancing manifolds, therefore the gas volumes in each pipeline are balanced without deploying a backup local scrubber or backup pipelines, or adjusting the point of admission. In other words, the present invention prevents the gas flow volume in the local scrubber and the pipeline from exceeding a limit and reduces the cost.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic drawing of a conventional local scrubber system and piping.

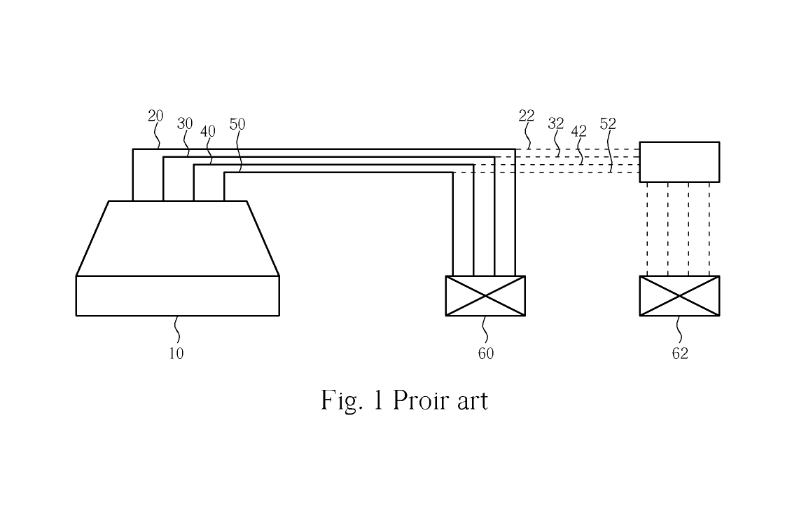

FIG. 2 is a schematic drawing of a scrubber system in semiconductor provided by a preferred embodiment of the present invention.

### DETAILED DESCRIPTION

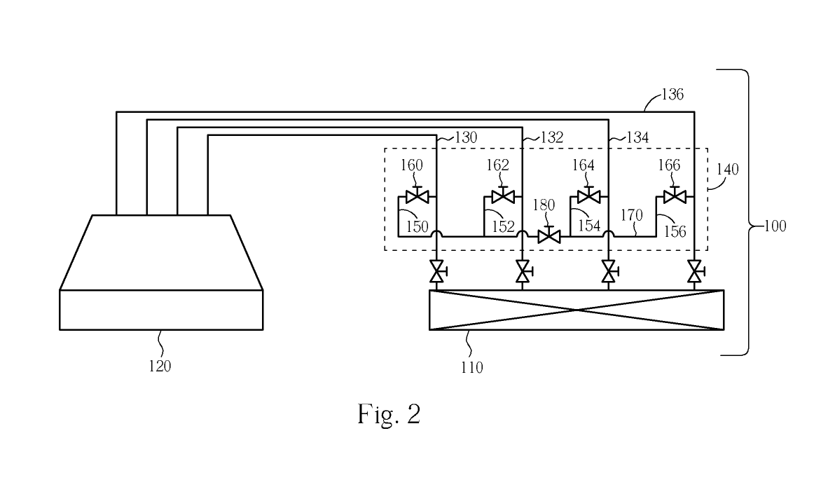

Please refer to FIG. 2, which is a schematic drawing of a scrubber system in semiconductor provided by a preferred embodiment of the present invention. As shown in FIG. 2, the scrubber system in semiconductor 100 is used to treat process exhaust gases from at least a process equipment 120. The scrubber system in semiconductor 100 comprises a local scrubber 110, a plurality of pipelines 130, 132, 134, 136 connecting the process equipment 120 to the local scrubber 110, and a flow balancing piping 140. The local scrubber 110 comprises a thermal-wet type local scrubber, a CDO local scrubber, a packing tower scrubber, or a dry scrubber. For clarifying the positions and relations of the ducts in the flow balancing piping 140, the flow balancing piping in FIG. 2 is drawn in with a dotted line. The flow balancing piping 140 comprises a connecting duct 170 and a plurality of flow balancing manifolds 150, 152, 154, 156, which respectively connect the pipelines 130, 132, 134, 136 to the connecting duct 170. The flow balancing piping 140 further comprises a plurality of first flow balancing valves 160, 162, 164, 166 respectively positioned on the flow balancing manifolds 150, 152, 154, 156, and a second flow balancing valve 180 positioned on the connecting duct 170.

The scrubber system in semiconductor 100 further comprises a plurality of pressure detectors (not shown) respectively positioned on the pipelines 130, 132, 134, 136 for detecting gas pressure in the pipelines 130, 132, 134, 136. The scrubber system in semiconductor 100 also comprises a display unit (not shown) used to display the detecting result from the pressure detectors, and thus the operators can monitor the gas pressure in the pipelines 130, 132, 134, 136 easily. The gas flow volumes in each pipeline 130, 132, 134, 136 have a limit, and the limit is equal to a quotient of the gas volume in the local scrubber and the number of the pipelines. For example, when the gas volume of the local scrubber 110 is 200 liters (L), the gas flow volumes in each of the pipeline 130, 132, 134, 136 are limited to 50 L.

It is noteworthy that the pipelines in the flow balancing piping 140 are grouped at least two-by-two. In this preferred embodiment, the pipeline 130 and the flow balancing manifold 150 are grouped with the pipeline 132 and the flow balancing manifold 152; the pipeline 134 and the flow balancing manifold 154 are grouped with the pipeline 136 and the flow balancing manifold 156. In the preferred embodiment, when the gas pressure in the pipeline 130 exceeds the limit of 50 L, the first flow balancing valves 160 and 162 are opened for connecting the flow balancing manifolds 150, 152, a portion of the connecting duct 170, and the pipelines 130 and 132. Therefore the excessive gas in the pipeline 130 flows into the pipeline 132 through the flow balancing manifold 150, the connecting duct 170, and the flow balancing manifold 152, whereby a balance is established between the pipelines 130 and 132. Accordingly, the gas flow volume in the pipeline 130 is reduced to under the limit. In the same concept, when the gas pressure in the pipeline 136 is over the limit of 50 L, the first flow balancing valves 164 and 166 are opened for connecting the flow balancing manifolds 154 and 156, a portion of the connecting duct 170, and the pipelines 134 and 136. Therefore the excessive gas in the pipeline 136 flows into the pipeline 134 through the flow balancing manifold 156, the connecting duct 170, and the flow balancing manifold 154, whereby a balance is established between the pipelines 134 and 136. Accordingly, the gas flow volume in the pipeline 136 is reduced to under the limit.

Moreover, the second flow balancing valve 180 is positioned on the connecting duct 170 and between two adjacent groups of the pipelines for controlling the connection between the two adjacent groups of the pipelines. For instance, when the gas flow volumes in the pipelines 130 and 132 are all over the limit, the first flow balancing valves 160 and 162 are opened, together with the second flow balancing valve 180 and the first flow balancing valve 164, which belongs to the adjacent group. Therefore, the flow balancing manifolds 150, 152, 154, the connecting duct 170, and the pipelines 130, 132, 134 are connected. The excessive gas in the pipelines 130, 132 of the same group is balanced by the pipeline 134 and reduced to under the limit. In the same concept, should the gas flow volume in the pipelines 130, 132, 134 still exceed the limit, the first flow balancing valve 166 is opened for connecting the pipeline 136 and the flow balancing manifold 166 for offering more balancing channels.

In the preferred embodiment, the flow balancing deployment is realized by grouping the pipelines two-by-two. However, this is not limited, as the flow balancing deployment can also be realized by grouping the pipelines three-by-three, depending on the design and requirements from the semiconductor foundries.

As mentioned above, through use of the flow balancing piping and the pipeline grouping deployment, the gas flow volumes in the pipelines of a same group are balanced in advance. And the pipelines of other groups can be involved depending on the practical situation. Therefore the scrubber system in semiconductor provided by the present invention prevents the gas flow volume in the pipelines and the local scrubber from exceeding the limit without deploying a backup local scrubber and backup pipelines or adjusting the point of admission, which increase cost greatly.

In addition, because of the deployment of the flow balancing piping, the gas flow volumes in the pipelines of the same group can substantially obtain an average. When the gases having averaged volume enter the local scrubber chamber, the disadvantage of incomplete combustion caused by the uneven gas distribution is avoided, therefore the temperature in the chamber is raised. In other words, the scrubber system in semiconductor provided by the present invention not only reduces cost but also improves combustion efficiency of the local scrubber.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A scrubber system in semiconductor comprising:
a local scrubber;
a plurality of pipelines connecting at least a process equipment to the local scrubber; and
a flow balancing piping comprising:
a connecting duct;
a plurality of flow balancing manifolds connecting the pipelines to the connecting duct;
a plurality of first flow balancing valves respectively positioned on the flow balancing manifolds; and
at least a second flow balancing valve positioned on the connecting duct to section the plurality of the pipelines into at least two groups.

2. The scrubber system of claim 1 wherein the local scrubber is a controlled decomposition/oxidation (CDO) local scrubber.

3. The scrubber system of claim 1 wherein the pipelines are grouped at least two-by-two.

4. The scrubber system of claim 1 further comprising a plurality of pressure detectors respectively positioned on the pipelines for detecting gas pressure in the pipelines.

5. The scrubber system of claim 4 further comprising a display unit displaying the detection results from the pressure detectors.

6. The scrubber system of claim 4, wherein when the gas pressure is over a limit, the first flow balancing valve is opened to connect the pipelines, the flow balancing manifolds in the same group, and the connecting duct.

7. The scrubber system of claim 6, wherein the limit is substantially equal to a quotient of the gas volume in the local scrubber and the number of the pipelines.

8. The scrubber system of claim 1, wherein when the gas pressures in the pipelines of the same group are all over a limit, the second flow balancing valve is opened to connect the pipeline, the flow balancing manifold of the two adjacent groups and the connecting duct.

9. The scrubber system of claim 8, wherein the limit is substantially equal to a quotient of the gas volume in the local scrubber and the number of the pipelines.
